(19) United States
(12) Patent Application Publication
(10) Pub. No.: US 2022/0176227 A1
(43) Pub. Date: Jun. 9, 2022

(54) VIRTUAL GOLF DEVICE, VIRTUAL GOLF SYSTEM AND METHOD FOR OPERATING A VIRTUAL GOLF DEVICE

(71) Applicant: SGM CO., LTD., Seongnam-si Gyeonggi-do (KR)

(72) Inventors: Ui Bum LEE, Seongnam-si Gyeonggi-do (KR); Kap Su KIM, Seoul (KR); Hyo Won AN, Yongin-si Gyeonggi-do (KR)

(21) Appl. No.: 17/544,922

(22) Filed: Dec. 7, 2021

(30) Foreign Application Priority Data
Dec. 9, 2020 (KR) 10-2020-0171355

(51) Int. Cl. A63B 71/06; A63B 67/02; A63B 24/00

(52) U.S. Cl. CPC A63B 71/0622; A63B 67/02; A63B 24/0021; A63B 2024/0031; A63B 2225/20; A63B 2225/50; A63B 2071/0644

(57) ABSTRACT

The present inventive concept relates to a virtual golf device, a virtual golf system and a method for operating a virtual golf device. The virtual golf device comprises a control part calculating a trajectory of a real golf ball when a user hits the real golf ball, and a display part displaying a virtual golf ball corresponding to the real golf ball hit by the user and moving according to the calculated trajectory in a virtual golf course. In this virtual golf device, the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

### TECHNICAL FIELD

The present disclosure relates to a virtual golf device, a virtual golf system and a method for operating a virtual golf device that provide a plurality of play modes where users can play the golf in various ways.

### BACKGROUND ART

Simulation apparatuses for enjoying sports games without going to fields have been developed by using 3D stereoscopic image and computer simulation technology so that virtual indoor sports games such as screen golf or screen baseball have come into wide use. For example, in the case of screen golf played indoors, images of a golf course are displayed through a screen. Therefore, it can give the feeling of playing a real golf game outside, and time and money can be saved in comparison with the play at an outdoor field. As a result, the screen golf is very popular among busy modern people who have difficulty in playing a real outdoor golf due to time or economic reasons, etc.

However, as the number of screen golf users increases, users' expectations are increasing. It is necessary for the screen golf to provide users with various contents that are specialized for the screen golf and not available in the real outdoor golf to enhance users' interest.

### DISCLOSURE

### Technical Problem

In order to solve the above-mentioned problems, the present inventive concept provides a virtual golf device providing a plurality of play modes where users can play in various ways according to their taste.

The present inventive concept provides an operating method that can be applied to the virtual golf device.

The present inventive concept provides a virtual golf system using the virtual golf device or the operating method.

The other objects of the present inventive concept will be clearly understood with reference to the following detailed description and the accompanying drawings.

### Technical Solution

In order to achieve the above-mentioned objects, a virtual golf device according to an embodiment of the present inventive concept comprises a control part calculating a trajectory of a real golf ball when a user hits the real golf ball, and a display part displaying a virtual golf ball corresponding to the real golf ball hit by the user and moving according to the calculated trajectory in a virtual golf course. In this virtual golf device, the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

In the virtual golf device, the user whose virtual golf ball is farthest away from a target point of the virtual golf course hits the real golf ball first in the first mode.

In the virtual golf device, one user among the plurality of users can hit the real golf ball at least two times in a row regardless of the location of the virtual golf ball of the corresponding user in the second mode.

In the virtual golf device, one user among the plurality of users can continuously hit the real golf ball from beginning to end in the virtual golf course in the second mode.

In the virtual golf device, the second mode is applied to a putting step.

The virtual golf device further comprises a hitting mat which the user places and hits the real golf ball on. In this virtual golf device, the hitting mat comprises a plurality of areas and the virtual golf course comprises a plurality of virtual areas corresponding to the plurality of areas of the hitting mat, when the virtual golf ball is located at one of the virtual areas the user should place and hit the real golf ball on one area of the plurality of areas of the hitting mat corresponding to the virtual area where the virtual golf ball is located, and the user can continuously hit the real golf ball while the real golf ball to be hit is placed at the same area of the hitting mat in the second mode.

A method for operating a virtual golf device according to an embodiment of the present inventive concept comprises a step of calculating a trajectory of a real golf ball when a user hits the real golf ball, and a step of displaying a virtual golf ball corresponding to the real golf ball hit by the user and moving according to the calculated trajectory in a virtual golf course. In this method, the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

The method for operating a virtual golf device further comprises a step of checking whether the user preparing for hitting the real golf is a correct user about the hitting order of the play mode currently selected.

A virtual golf system according to an embodiment of the present inventive concept comprises a virtual golf device and a server unit connected to the virtual golf device through a communication network. The virtual device comprises a control part calculating a trajectory of a real golf ball when a user hits the real golf ball, and a display part displaying a virtual golf ball corresponding to the real golf ball hit by the user and moving according to the calculated trajectory in a virtual golf course. In addition, the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

In the virtual golf system, the server unit comprises a storage unit for storing user's personal information, and the play mode can be set based on the user's personal information without the user's selection.

### Advantageous Effects

According to a virtual golf device, a virtual golf system and a method for operating a virtual golf device of the present inventive concept, users can play screen golf in various ways in accordance with their taste.

### BRIEF DESCRIPTION OF THE DRAWINGS

FIG. 1 shows a schematic structure of a virtual golf device according to an embodiment of the present inventive concept.

FIGS. 2 to 7 are views for explaining first and second modes.

FIGS. 8 to 10 are views for explaining a modified example of the second mode.

FIG. 11 shows a schematic structure of a virtual golf device according to another embodiment of the present inventive concept.

FIGS. 12 and 13 show examples of executing the selection of the first and second modes in the virtual golf device.

FIG. 14 shows a process of a method for operating a virtual golf device according to an embodiment of the present inventive concept.

FIG. 15 shows a schematic structure of a virtual golf device according to another embodiment of the present inventive concept.

FIG. 16 shows a schematic structure of a virtual golf system according to an embodiment of the present inventive concept.

FIG. 17 shows one example of the structure of the storage unit of the virtual golf system of FIG. 16.

### DETAILED DESCRIPTION

Hereinafter, a detailed description will be given of the present inventive concept with reference to the following embodiments. The purposes, features, and advantages of the present inventive concept will be easily understood through the following embodiments. The present inventive concept is not limited to such embodiments but may be modified in other forms. The embodiments to be described below are nothing but the ones provided to bring the disclosure of the present inventive concept to perfection and assist those skilled in the art to completely understand the present inventive concept. Therefore, the following embodiments are not to be construed as limiting the present inventive concept.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. It will be understood that when an element is referred to as being “on” another element, it can be directly on the other element or intervening elements may be present therebetween.

The size of the element or the relative sizes between elements in the drawings may be shown to be exaggerated for more clear understanding of the present inventive concept. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

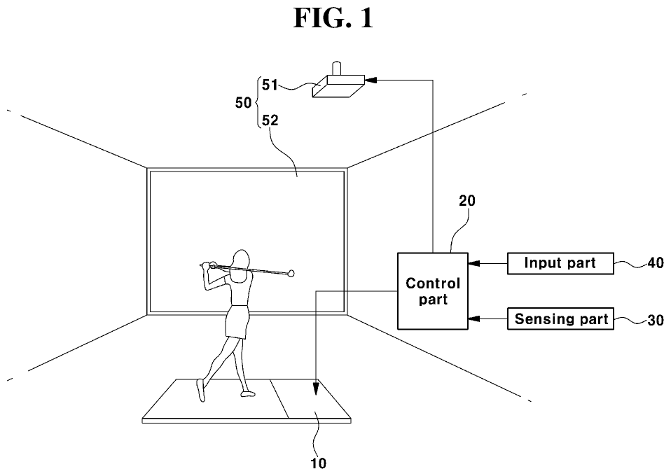

FIG. 1 shows a schematic structure of a virtual golf device according to an embodiment of the present inventive concept.

Referring to FIG. 1, the virtual golf device comprises a hitting plate 10, a control part 20, a sensing part 30, an input part 40 and a display part 50.

There is a hitting mat in the hitting plate 10 and a golf ball to be hit is placed on the hitting mat. A user is located at the hitting plate 10 and hits the golf ball placed on the hitting mat.

The control part 20 controls the overall operation between the components of the virtual golf device. For example, an auto tee that automatically provides the golf ball to be hit may be installed on the hitting mat although not shown in FIG. 1, and the control part 20 can provide the golf ball to the user at the time of hitting the golf ball by controlling the auto tee. In addition, when the user hits the golf ball, the control part 20 assumes that the golf ball flies at an outdoor golf course to compute the result of hitting the golf ball (trajectory, flying distance and the like).

The sensing part 30 senses the physical state of the golf ball hit by the user such as a speed, a moving direction, a rotation angle, etc. The sensing part 30 includes a sensing means capable of sensing the physical state of the golf ball. As the sensing means, a camera or a sensor can be used. The camera or the sensor may be used alone or used together, and only one sensing unit may be used or several sensing units may be used if circumstances need. The information detected by the sensing part 30 is transmitted to the control part 20, and the control part 20 calculates the trajectory or flying distance of the golf ball based on the information sensed by the sensing part 30.

The input part 40 is needed for the user to input various information. As the input part 40, a keyboard, a mouse or a touch screen can be used. In the screen golf, the information input by the user is needed for various cases. For example, when the user inputs ID or password for login or selects a golf course or a play difficulty level, the user needs to input the related information. The input part 40 is provided for this object. Information input through the input part 40 is transmitted to the control part 20, and the control part 20 processes the user's request based on the transmitted information. For example, when the user selects a specific golf course, an image processing means included in the control part 20 generates the corresponding golf course image to deliver the display part 50 so that the image is displayed to the user. Also, when the user inputs personal information such as ID and/or password for login, the control part 20 may check the input personal information to determine whether to approve the login.

The display part 50 includes a projector 51 and a screen 52. The projector 51 gives the golf-related image with the golf ball and/or the golf course to the screen 52, and the screen 52 displays the given image to provide it to the user. Hereinafter, some objects displayed on the screen 52 may be expressed by using the term ‘virtual’. This means that it does not exist in the real world and is displayed on the screen 52. For example, ‘virtual golf course’ means a golf course displayed on the screen 52 and ‘virtual golf ball’ means a golf ball displayed on the screen 52.

Although not shown in FIG. 1, the virtual golf device may include a sound apparatus such as a speaker or the like. The sound apparatus informs the user of the information about the progress of the golf play and reproduces various sound effects according to the progress of the golf play.

By using the virtual golf device, the user can play screen golf. When the user plays screen golf, the virtual golf device operates as follows. When the user hits a golf ball on the hitting plate 10, the control part 20 computes the trajectory of the golf ball based on the information sensed by the sensing part 30 and the image of the virtual golf ball is displayed in the screen 52. The virtual golf ball in the screen 52 moves along the computed trajectory and then lands at one location point in the virtual golf course in the screen 52. The user redoes the screen golf play from the location where the virtual golf ball landed by hitting the golf ball, the control part 20 recomputes the trajectory of the golf ball, and the virtual golf ball moving along the recomputed trajectory is displayed in the screen 52. This process is repeated until the virtual golf ball is put into the hole cup of the virtual golf course. In this screen golf play, the virtual golf device of the present inventive concept provides various play modes so that the user can play in various ways. When a plurality of users play together, the play modes relate to a method of determining a hitting order between users and includes first and second modes. Hereinafter, the first and second modes will be explained.

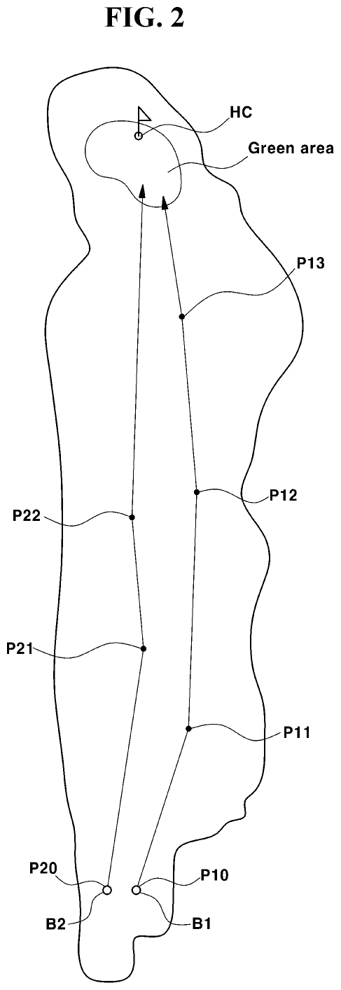

FIGS. 2 to 7 are views for explaining first and second modes.

It is assumed that users A1 and A2 play screen golf together in the virtual golf device of FIG. 1. Referring to FIG. 2, there is a virtual golf ball for user A1 (‘first golf ball (B1)’) at an initial position (P10) in the virtual golf course. As user A1 hits his or her golf ball placed on the hitting mat, the position of the first golf ball (B1) is changed to the first position (P11), the second position (P12) and the third position (P13). When user A1 hits the golf ball of the hitting mat corresponding to the first golf ball (B1) of the third position (P13), the first golf ball (B1) enters a green area in the virtual golf course. In the case of user A2, there is a virtual golf ball for user A2 (‘second golf ball (B2)’) at an initial position (P20) in the virtual golf course. As the user A2 hits his or her golf ball placed on the hitting mat, the position of the second golf ball (B2) is changed to the first position (P21) and the second position (P22). When user A2 hits the golf ball of the hitting mat corresponding to the second golf ball (B2) of the second position (P22), the second golf ball (B2) enters the green area in the virtual golf course. Hereinafter, the process of hitting the golf ball before entering the green area is called ‘shot step’.

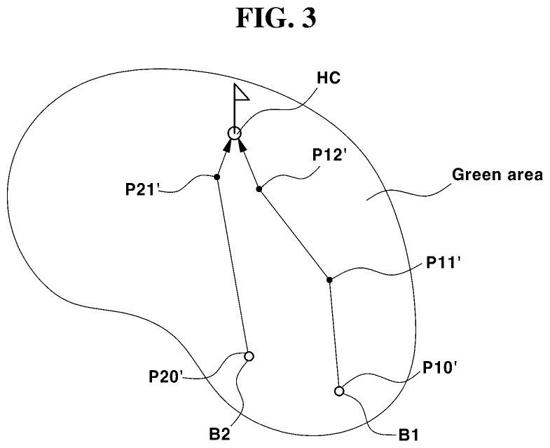

Referring to FIG. 3, users A1 and A2 putt in the green area. In the case of user A1, the position of the first golf ball (B1) is changed from an initial position (P10′) to the first position (P11′) and the second position (P12′) by the putting of user A1, and the first golf ball (B1) is put into the hole cup (HC) by the putting of user A1 at the second position (P12′). In the case of user A2, the position of the second golf ball (B2) is changed from an initial position (P20′) to the first position (P21′) by the putting of user A2, and the second golf ball (B2) is put into the hole cup (HC) by the putting of user A2 at the first position (P21′). Hereinafter, the putting process in the green area is called ‘putting step’.

When the positions of the first and second golf balls (B1, B2) are changed as shown in FIGS. 2 and 3, the order where users A1 and A2 hit the golf ball in the first and second modes is as follows.

The hitting order in the first mode can be determined by the position of the golf ball to be hit. Specifically, the hitting order depends on the distance between the virtual golf ball and the hole cup, the final target point of the virtual golf course. The user whose virtual golf ball is farthest away from the hole cup hits the golf ball first in the first mode.

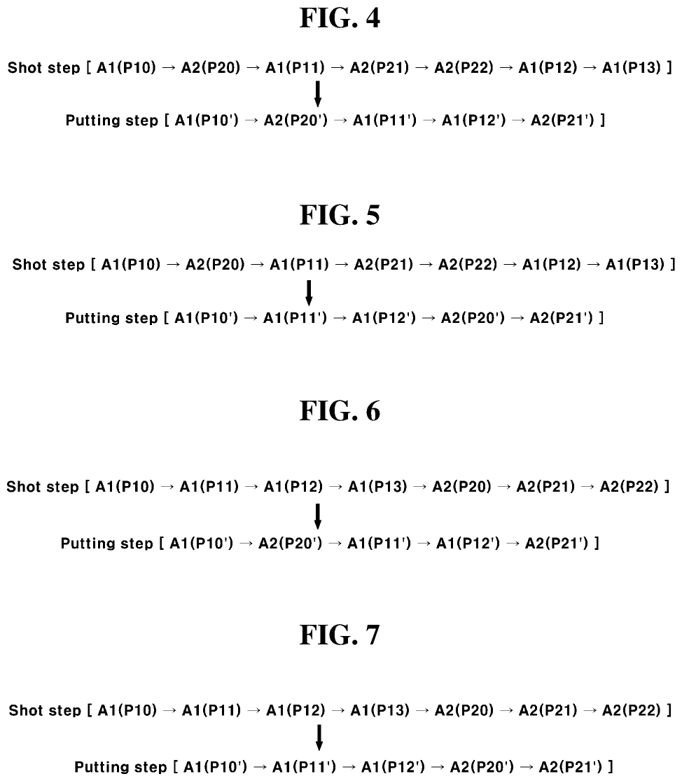

When the positions of the first and second golf balls (B1, B2) are changed as shown in FIGS. 2 and 3, the hitting order in the first mode is shown in FIG. 4. Referring to FIGS. 2 and 4, the distance between the first golf ball (B1) and the hole cup (HC) does not differ substantially from the distance between the second golf ball (B2) and the hole cup (HC) at the initial positions (P10, P20) of the shot step. Therefore, it does not matter whether anyone of users A1 and A2 hits first. It is assumed that user A1 hits first. The user A1 hits a real golf ball placed on the hitting mat and corresponding to the first golf ball (B1) located at the initial position P10, and the first golf ball (B1) is moved to the first position (P11) by the hit of the user A1. The first position (P11) of the first golf ball (B1) is closer to the hole cup (HC) than the initial position (P20) of the second golf ball (B2) of the user A2, so the current hitting order according to the first mode is the user A2. The user A2 needs to hit a real golf ball placed on the hitting mat and corresponding to the second golf ball (B2) located at the initial position (P20). The second golf ball (B2) is moved to the first position (P21) by the hit of the user A2. The first position (P21) of the second golf ball (B2) is closer to the hole cup (HC) than the first position (P11) of the first golf ball (B1). In the first mode, the current hitting order is the user A1 whose golf ball (B1) is located at the first position (P11). The first golf ball (B1) is moved from the first position (P11) to the second position (P12) by the hit of the user A1. The second position (P12) of the first golf ball (B1) is closer to the hole cup (HC) than the first position (P21) of the second golf ball (B2) of the user A2. The current hitting order is the user A2 whose golf ball (B2) is located at the first position (P21). The second golf ball (B2) is moved from the first position (P21) to the second position (P22) by the hit of the user A2. The second position (P12) of the first golf ball (B1) is closer to the hole cup (HC) than the second position (P22) of the second golf ball (B2). The current hitting order is the user A2 whose golf ball (B2) is located at the second position (P22). The second golf ball (B2) enter the green area by the hit of the user A2. Since the second position (P12) of the first golf ball (B1) is outside the green area, the current hitting order is the user A1. The first golf ball (B1) is moved from the second position (P12) to the third position (P13) by the hit of the user A1. Since the third position (P13) of the first golf ball (B1) is still outside the green area, the current hitting order is also the user A1. The first golf ball (B1) enters the green area by the hit of the user A1. As a result, the shot step ends and the putting step begins.

The hitting order in the putting step also depends on the distance between the golf balls (B1, B2) and the hole cup (HC). Referring to FIGS. 3 and 4, as the result of the shot step, the initial position (P10′) of the first golf ball (B1) in the green area is farther away from the hole cup (HC) than the initial position (P20′) of the second golf ball (B2). Therefore, the current putting order is the user A1 whose golf ball (B1) is located at the initial position (P10′). The first golf ball (B1) is moved from the initial position (P10′) to the first position (P11′) by the putting of the user A1. The first position (P11′) of the first golf ball (B1) is closer to the hole cup (HC) than the initial position (P20′) of the second golf ball (B2). The current putting order is the user A2 whose golf ball (B2) is located at the initial position (P20′). The second golf ball (B2) is moved from the initial position (P20′) to the first position (P21′) by the putting of the user A2. The first position (P21′) of the second golf ball (B2) is closer to the hole cup (HC) than the first position (P10′) of the first golf ball (B1). The current putting order is the user A1 whose golf ball (B1) is located at the first position (P11′). The first golf ball (B1) is moved from the first position (P11′) to the second position (P12′) by the putting of the user A1. The first position (P21′) of the second golf ball (B2) is still closer to the hole cup (HC) than the second position (P12′) of the first golf ball (B1). Therefore, the current putting order is also the user A1 whose golf ball (B1) is located at the second position (P12′). The first golf ball (B1) enters the hole cup (HC) from the second position (P12′) by the putting of user A1, and the putting order is now the user A2 whose golf ball (B2) is located at the first position (P21′). The second golf ball (B2) enters the hole cup (HC) from the first position (P21′) by the putting of user A2, and the play of users A1 and A2 ends at the current virtual golf course. If the current virtual golf course is not the last course among all golf courses, users A and B begin the screen golf play at the next course. If the current virtual golf course is the last course, the screen golf play between users A1 and A2 ends.

The first mode is used in actual golf to screen golf. The reason why a golfer whose golf ball is farthest away from the hole cup hits his/her golf ball first in actual golf is that golfers who play together can hit the golf ball along the order in which the golf balls are disposed in a golf course while moving together from the starting point to the target point (hole cup). For example, it is assumed that golfers A1 and A2 are playing together at an actual outdoor golf course, and the golf ball of golfer A1 flies further than that of golfer A2 by tee shot from the starting point so that the golf ball of golfer A1 is closer to the target point than the golf ball of golfer A2. After the tee shot, golfers A1 and A2 move together to their golf ball positions for the next hit. Since the golf ball of golfer A2 is farther away from the target point than the golf ball of golfer A1, the golf ball of golfer A2 is closer to the starting point than the golf ball of golfer A1. Therefore, golfers A1 and A2 arrive at the golf ball position of golfer A2 first and the golf ball position of golfer A1 later. According to the hitting order that a golfer whose golf ball is farthest away from the hole cup hits his/her golf ball first, golfer A2 can hit the golf ball first at the position where golfers A1 and A2 arrive first and golfer A1 can hit the golf ball later at the position where golfers A1 and A2 arrive later. If the hitting order for golfers A and B is opposite to that mentioned above under the same situation, golfer A1 hits the ball and then golfer A2 hits the golf ball. In this case, when golfer A2 hit the golf ball, there is a possibility that golfer A1 gets hit by the golf ball hit by golfer A2 since the position of golfer A1 who hit the golf ball first is in front of golfer A2. In order to prevent this problem, a golfer whose golf ball is farthest away from the hole cup hits his/her golf ball first in actual golf. In the first mode of the present inventive concept, the hitting order of actual golf is applied to screen golf as it is.

FIGS. 5 to 7 show various hitting order in the second mode. The hitting order in the second mode can be determined regardless of the position of the golf ball to be hit. It is assumed that users A1 and A2 play screen golf together and the play situation in the shot step and putting step is the same as what is illustrated in FIG. 2 and FIG. 3.

Under the second mode, the hitting order is identical to that of the first mode in some sections of the entire virtual golf course and is different from that of the first mode in other sections of the entire virtual golf course. Concretely, the hitting order of the second mode is identical to that of the first mode in the shot step. In the putting step of the second mode, anyone of users A1 and A2 waits for the other user to complete the putting step and then begins his/her putting step regardless of the position of the golf ball of users A1 and A2.

Referring to FIGS. 2, 4 and 5, the hitting order in the shot step of the second mode is the same as the hitting order in the shot step of the first mode. Referring to FIGS. 3 and 5, in the putting step of the second mode, the initial position (P10′) of the first golf ball (B1) is farther away from the hole cup (HC) than the initial position (P20′) of the second golf ball (B2), and the user A1 first putts the real golf ball placed on the hitting mat and corresponding to the first golf ball (B1) (It is possible for user A2 to putt first the golf ball in the putting step of this play mode). The position of the first golf ball (B1) is changed from the initial position (P10′) of the green area to the first position (P11′) by the putting of user A1, and the first position (P11′) is closer to the hole cup (HC) than the initial position (P20′) of the second golf ball (B2) of the user A2. At this situation, the hitting order in the first mode is user A2 whose golf ball is located at the initial position (P20′), but user A1 who begins the putting first continues the putting to finish his/her putting step in the second mode. The first golf ball (B1) is moved from the initial position (P10′) to the first position (P11′) by the first putting of the user A1, the first golf ball (B1) is moved from the first position (P11′) to the second position (P12′) by the second putting of the user A1, and the first golf ball (B1) is put into the hole cup (HC) by the third putting of the user A1 so that the putting step for user A1 is completed. After the putting step of user A1 is completed, the putting step of user A2 begins. The second golf ball (B2) is moved from the initial position (P20′) to the first position (P21′) by the first putting of the user A2, and the second golf ball (B2) is put into the hole cup (HC) by the second putting of the user A2 so that the putting step for user A2 is completed.

As described above, in the second mode according to the present embodiment, the hitting order in the shot step is the same as the hitting order of the first mode, and the hitting order in the putting step is different from the hitting order of the first mode. In the putting step of the second mode, one user can continue the putting and the other user(s) waits for the user starting the putting to complete it. Since putting is putting a golf ball into a very small hole cup, it requires a high degree of concentration. Therefore, it may be advantageous for users to continuously putt in a state where the concentration is raised, and the second mode according to the present embodiment can utilize this aspect.

In another example of the second mode, the hitting order is identical to that of the first mode in putting step and is different from that of the first mode in shot step. In the shot step of this second mode, regardless of the location of the golf ball of users A1 and A2, any one user continues to hit the golf ball until the golf ball enter the green area and then the other user beings the shot step and continue hitting the golf ball until the golf ball enters the green area.

Referring to FIGS. 2 and 6, in the shot step of the second mode, the user A1 first hits the real golf ball placed on the hitting mat and corresponding to the first golf ball (B1) located at the initial position (P10) (It is possible for user A2 to hit the golf ball first in the shot step of this play mode). The initial position (P10) of the first golf ball (B1) is changed to the first position (P11) by the hit of the user A1, and this position (P11) is closer to the hole cup (HC) than the initial position (P20) of the second golf ball (B2) of the user A2. At this situation, the hitting order in the first mode is user A2 whose golf ball is located at the initial position (P20), but user A1 who hit the golf ball first continues hitting the golf ball in the second mode. The first golf ball (B1) is moved from the initial position (P10) to the first position (P11) by the first shot of the user A1, the first golf ball (B1) is moved from the first position (P11) to the second position (P12) by the second shot of the user A1, the first golf ball (B1) is moved from the second position (P12) to the third position (P13) by the third shot of the user A1, and the first golf ball (B1) reaches the green area by the fourth shot of the user A1 so that the shot step for user A1 is completed. After the shot step of user A1 is completed, the shot step of user A2 begins. The second golf ball (B2) is moved from the initial position (P20) to the first position (P21) by the first shot of the user A2, the second golf ball (B2) is moved from the first position (P21) to the second position (P22) by the second shot of the user A2, and the second golf ball (B2) reaches the green area by the third shot of the user A2 so that the shot step for user A2 is completed. After the shot step for users A1 and A2 ends, the putting step begins. The hitting order in the putting step of the second mode is the same as the hitting order in the putting step of the first mode.

As described above, in the shot step of this second mode, one user can continue hitting the golf ball and the other user(s) begins his/her shot step after the user hitting the golf ball first completed the shot step. In addition, the hitting order in the putting step is the same as the hitting order of the first mode. The reason why a golfer whose golf ball is farthest away from the hole cup hits his/her golf ball first in actual golf is that golfers who play together can hit the golf ball in the order in which the golf balls are disposed in the golf course while moving together from the starting point to the hole cup. However, in screen golf, the golf balls of users are displayed as virtual golf balls on the screen, and thus users don't need to move to the positions of their virtual golf balls. Therefore, it is not necessary to apply the method of determining the hitting order used in the actual golf to screen golf. The second mode described here reflects this aspect, and thus one user can hit the golf ball continuously in the shot step.

In addition to the methods described above, various methods may be applied to the second mode.

As an example of another method, one user can hit the golf ball continuously in the shot step and the putting step. Referring FIGS. 2 and 7, in the shot step, user A1 continues hitting the golf ball until the first golf ball (B1) of the user A1 reaches the green area, and then user A2 continues hitting the golf ball until the second golf ball (B2) of the user A2 reaches the green area. Referring FIGS. 3 and 7, in the putting step, user A1 continues the putting until the first golf ball (B1) of the user A1 is put into the hole cup (HC), and then user A2 continues the putting until the second golf ball (B2) of the user A2 is put into the hole cup (HC).

In addition, as another method of the second mode, although not shown in the drawings, anyone of a plurality of users can make consecutive hits from beginning (tee shot) to end (hole-in) at one virtual golf course, and when first user completes the play for the virtual golf course second user can continuously make hits on the corresponding course, and then next user can do the same thing. Users may think that it is advantageous or convenient to hit the golf ball many times at once and take a break while other users are hitting rather than to alternately hit the golf ball together with other users.

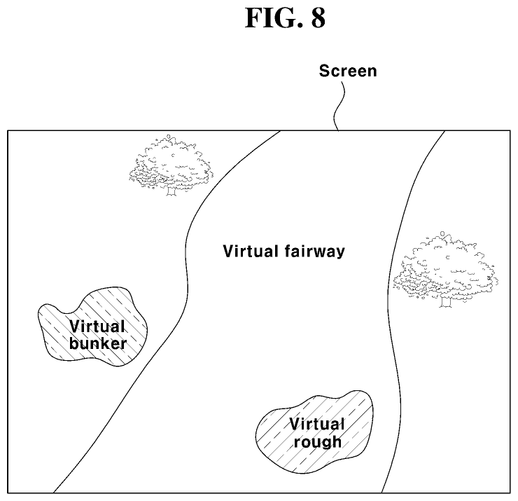

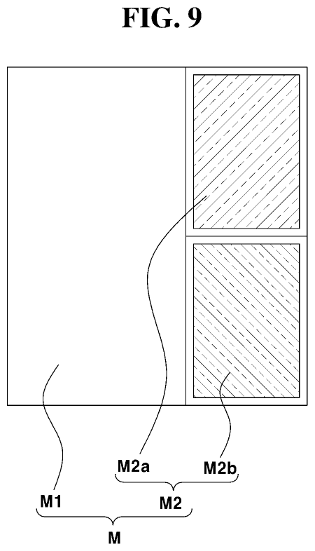

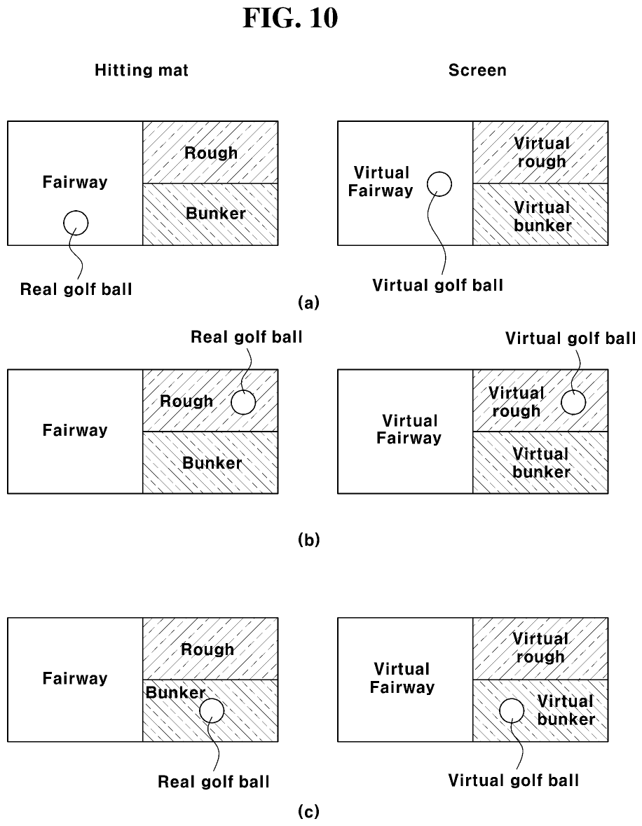

FIGS. 8 to 10 are views for explaining a modified example of the second mode. FIG. 8 shows an example of a virtual golf course that may be displayed on the screen of the virtual golf device of FIG. 1, FIG. 9 shows a multi-region hitting mat that may be used for the virtual golf device of FIG. 1, and FIG. 10 shows cases in which the virtual golf ball of the virtual golf course and the real golf ball of the hitting mat are placed at positions corresponding to each other when the virtual golf course of FIG. 8 and the multi-region hitting mat of FIG. 9 are used.

Referring to FIG. 8, a virtual golf course is displayed on the screen during screen golf play. The virtual golf course is made based on an actual golf course or is created as a non-real golf course by using computer graphics. Whether it is based on an actual golf course or a created golf course, the virtual golf course displayed on the screen reflects the characteristics of the actual golf course as much as possible in order to improve the reality of screen golf. For example, just as an actual golf course includes various terrain such as fairway, rough and bunker, various virtual terrain such as virtual fairway, virtual rough and virtual bunker is also displayed on the virtual golf course of the screen. In an actual golf course, the fairway is a region that consists of grass and it is easy to hit a golf ball in the grass of the fairway. The rough is a region including grass which is longer than that of the fairway so that it is not easy to hit a golf ball in the rough. A bunker is a region that consists of sand and it is difficult to hit a golf ball in the bunker, so the difficulty of hitting a golf ball is high in comparison with grass regions (fairway, rough).

Referring to FIG. 9, the hitting plate is provided with a hitting mat (M) on which a golf ball to be hit is placed, and the hitting mat (M) is divided into a plurality of regions. This multi-region hitting mat (M) may have a first hitting region (M1) and a second hitting region (M2) having two sub-regions (M2a, M2b). The first hitting region (M1) corresponds to a fairway having the lowest hitting difficulty in actual golf, and the second hitting region (M2) corresponds to a non-fairway (rough, bunker, etc.) having a higher hitting difficulty than a fairway. In addition, the two sub-regions (M2a, M2b) of the second hitting region (M2) corresponds to rough and bunker having different hitting difficulties, respectively. For example, the first hitting region (M1) and one sub-region (M2a) of the second hitting region (M2) in the hitting mat (M) can be formed of artificial turf with different lengths that can give a feeling of hitting a golf ball in the fairway and the rough of the actual golf. The remaining sub-region (M2b) of the second hitting region (M2) in the hitting mat (M) can be formed of a material that can give a feeling of hitting a golf ball in sand. In this way, the multi-region hitting mat (M) can be divided into three regions having different hitting difficulty and/or hitting feeling. In actual golf, there may be terrain such as water hazards other than fairways, roughs and bunkers, and roughs or bunkers can also be subdivided into light rough, heavy rough, fairway bunkers, green bunkers, etc. Therefore, the multi-region hitting mat (M) is not necessarily limited to the structure shown in FIG. 9 and may be formed in various structure in order to reflect various topographical characteristics of an actual golf course. However, since roughs and bunkers are the highest-rated regions among non-fairway regions in most actual golf courses, the two sub-regions (M2a, M2b) of the second hitting region (M2) may be referred to as rough region and bunker region, respectively. Also, the first and second hitting regions (M1, M2) may be referred to as fairway region and non-fairway region, respectively.

In the case of using a multi-region hitting mat (M), the hitting mat (M) can provide users with a variety of hitting environments corresponding to various situations where a virtual golf ball is placed in the screen. As shown in FIG. 10(a), when a virtual golf ball in the screen is placed on the virtual fairway, if the user places a real golf ball on the fairway region to hit it, the hitting environment in the hitting mat (M) corresponds to the situation in the screen. As shown in FIG. 10(b), when a virtual golf ball in the screen is placed on the virtual rough, if the user places a real golf ball on the rough region to hit it, the hitting environment in the hitting mat (M) corresponds to the situation in the screen. As shown in FIG. 10(c), when a virtual golf ball in the screen is placed on the virtual bunker, if the user places a real golf ball on the bunker region to hit it, the hitting environment in the hitting mat (M) corresponds to the situation in the screen.

One method that can be applied to the second mode is to allow the user to continuously hit his/her golf ball as long as the golf ball to be hit should be place at the same region of the hitting mat (M). For example, it is assumed that there are users A1 and A2 and that user A1 hits first under the second mode according to the present method. When user A1 begins to hit the golf ball (tee shot) on a certain virtual golf course, the virtual golf ball for the tee shot is placed on the virtual fairway, and thus user A1 should place the real golf ball on the fairway region of the hitting mat and hit it (‘first fairway shot’). As a result of the first fairway shot, if the virtual golf ball of user A1 lands on the virtual fairway, user A1 should place the real golf ball on the fairway region of the hitting mat and hit it again (‘second fairway shot’). As a result of the second fairway shot, if the virtual golf ball of user A1 has lands on the virtual rough, user A1 should place the real golf ball on the rough region of the hitting mat and hit it (‘first rough shot’). In this case, the first and second fairway shots are to hit the real golf ball placed on the same region of the hitting mat (fairway region), and the first rough shot is to hit the real golf ball placed on the different region of the hitting mat (rough region).

In the second mode of this method, the user can continuously hit the real golf ball when the golf ball to be hit is placed on the same region of the hitting mat (M). Therefore, user A1 can continuously performs the first and second fairway shots, user A2 performs his/her shot(s), and then user A1 can perform the first rough shot.

If the region of the hitting mat for a first shot is the same as the region of the hitting mat for a second shot, the feeling of hitting the golf ball in the first and second shots is also the same. It may be advantageous for the user to hit the golf ball continuously while the user can maintain the same hitting feeling. If the region of the hitting mat for a first shot is different from the region of the hitting mat for a second shot, the hitting feeling in the first and second shots is not maintained. It may be disadvantageous for the user to hit the golf ball continuously if it is not possible to maintain the hitting feeling. The second mode of this method reflects this aspect.

Various methods of the second mode that can determine the hitting order regardless of the position of the golf ball have been described above, but these are only a few examples to help understanding and other methods not described herein may be applied.

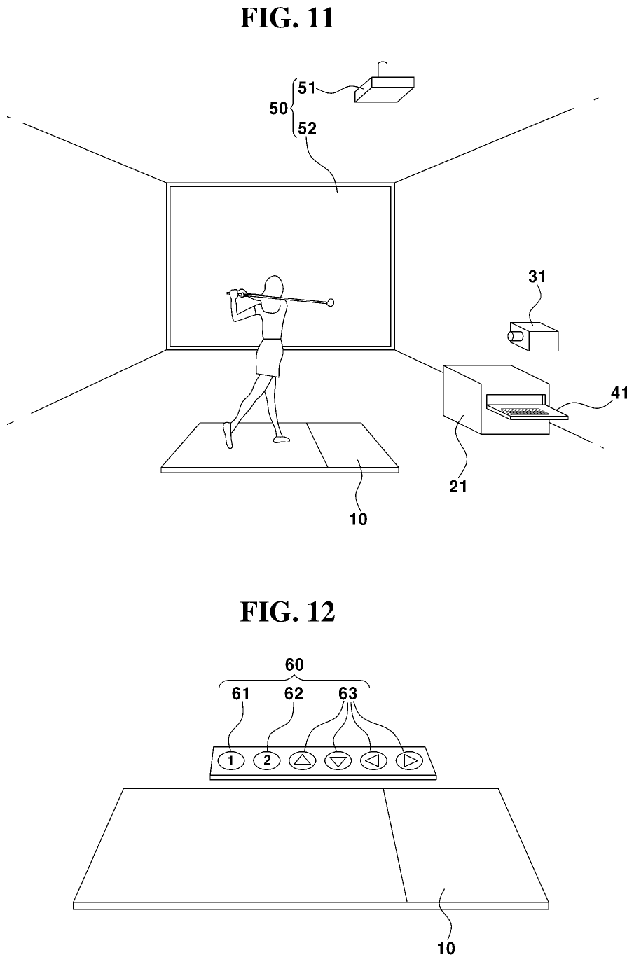

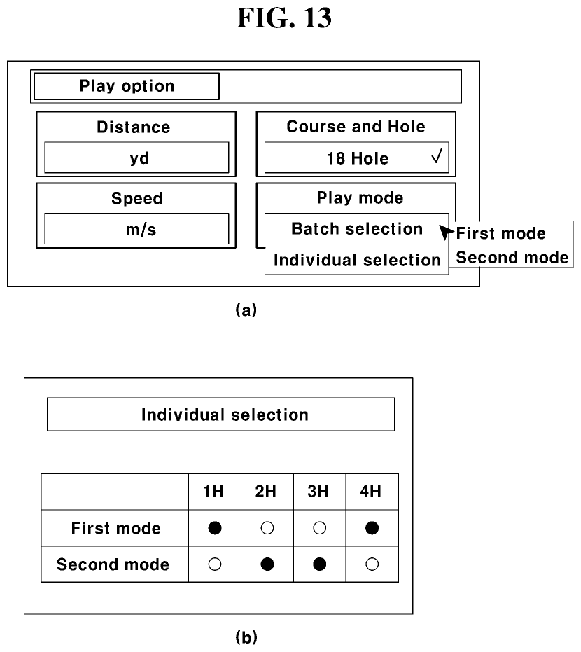

FIG. 11 shows a schematic structure of a virtual golf device according to another embodiment of the present inventive concept, and FIGS. 12 and 13 show examples of executing the selection of the first and second modes in the virtual golf device.

Referring to FIG. 11, the virtual golf device according to this embodiment comprises a hitting plate 10, a control unit 21, a sensing unit 31, an input unit 41 and a display part 50. The hitting plate 10 serves as a hitting zone where the user places a golf ball to be hit. The control unit 21 plays a role of the control part in the embodiment described with reference to FIG. 1. As the control unit 21, a computer in which software having a function of calculating the trajectory of a golf ball is installed may be used. The sensing unit 31 serves as the sensing part in the embodiment described with reference to FIG. 1. As the sensing unit 31, a camera capable of detecting the physical state of a golf ball may be used. The input unit 41 serves as an input part in the embodiment described with reference to FIG. 1. As the input unit 41, a keyboard or mouse having an input function may be used. The display part 50 includes a projector 51 and a screen 52. The projector 51 gives the golf-related image with the golf ball and/or the golf course to the screen 52, and the screen 52 displays the given image to provide it to the user. Although not shown in FIG. 11, the virtual golf device may include a sound unit informing the user of the golf play information and reproducing various sound effects according to the progress of the golf play.

Like the virtual golf device described with reference to FIG. 1, first and second modes relating to a method of determining a hitting order between a plurality of users can be applied to the virtual golf device of this embodiment. Users can select a desired play mode at any time before or during the screen golf play, and a separate interface apparatus 60 may be provided for the selection.

Referring to FIG. 12, the interface apparatus 60 is disposed near the hitting plate 10. A user located at the hitting plate 10 to hit a golf ball uses the nearby interface apparatus 60 to conveniently select one play mode of the first and second modes at any time. For example, the interface apparatus 60 has ‘button \textcircled{1} 61’ for selecting the first mode and ‘button \textcircled{2} 62’ for selecting the second mode, and the user can easily select the desired mode of the first and second modes by stepping on one of button \textcircled{1} 61 and button \textcircled{2}. In addition to buttons for selecting the first and second modes, the interface apparatus 60 may further include other buttons 63 for inputting commands frequently used by the user during screen golf play. For example, the other button 63 may have function of adjusting the angle or position at which the picture in the screen is viewed.

The interface apparatus 60 is not essential. Even if there is no interface apparatus, the user can use the input unit 41 or the like to select one play mode of the first and second modes before or during the screen golf play. Referring to FIG. 13, a menu for selecting user's play options is displayed on the screen. This menu can be displayed on a kiosk (not shown in drawings) that may be provided separately. In general, an actual golf field is composed of 18 holes (18 different golf courses). In screen golf, if a user selects a specific golf field to be played, a plurality of golf courses belonging to the selected golf field are available. In screen golf, users can play 18 holes game as in actual golf or play abbreviated game (for example, 9 holes game which is half of 18 holes), and this can be selected on the play option menu. In addition, in the play option, a unit for showing distance or speed can be selected, and one play mode of the first and second modes can be selected in relation to the hitting order. In selecting the first mode or the second mode, batch selection is available as shown in FIG. 13(a) or individual selection is available as shown in FIG. 13(b). In the batch selection, one play mode of the first and second modes can be selected at once about all golf courses (for example, 18 golf courses in 18 holes game). In the individual selection, one play mode of the first and second modes can be individually selected per each hole of all golf courses. When the user does not select the play mode, the first mode which is used in actual golf may be automatically selected. Alternatively, when the user does not select the play mode, any one of the first and second modes may be randomly selected.

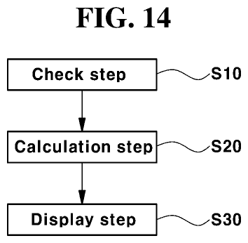

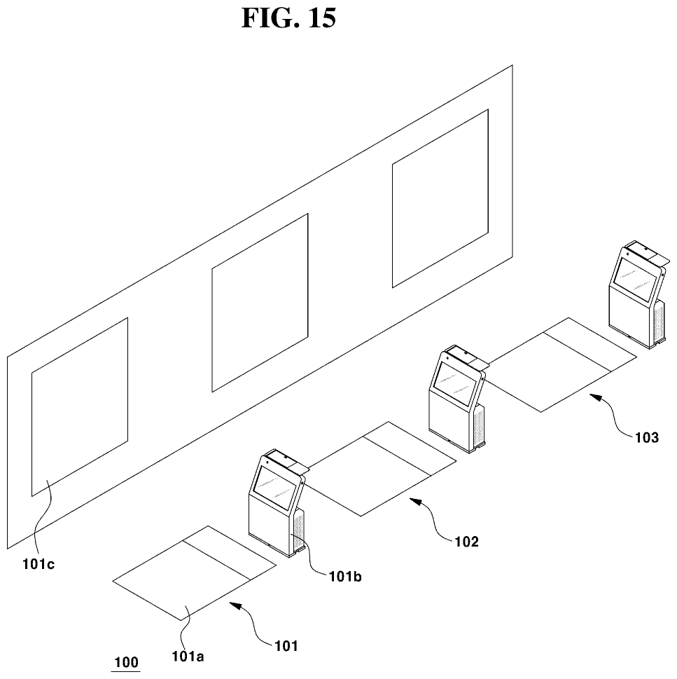

When the virtual golf device providing a plurality of play modes is used, it is necessary to check whether the screen golf play is consistent with the play mode selected by users. FIG. 14 shows one example of several operating methods applicable to a virtual golf device that provides a plurality of play modes.

Referring to FIG. 14, the method for operating the virtual golf device according to the present embodiment comprises a check step S10, a calculation step S20 and a display step S30.

In the check step S10, before the user hits the real golf ball, it is checked who is the user who meets the hitting order based on the currently applied play mode. For example, if users A1 and A2 are playing in the first mode and the virtual golf ball of user A1 is farther away from the hole cup of the screen than the virtual golf ball of the user A2, the current hitting order is the user A1. In the check step S10, a control means such as the control part checks that the first mode is currently applied and the virtual golf ball of user A1 is farther away from the hole cup, and then determines that the current hitting order is user A1. At this time, a text message such as “The current hitting order is user A1.” may be displayed on the screen or the voice message may be provided to the user by a sound means. If there is a camera sensing who is currently located at the hitting plate among users A1 and A2, a text message or/and a sound message such as “Since the current hitting order is user A1, user A2 should step away from the hitting plate.” can be provided so that user A1 in the correct hitting order can hit the golf ball.

When the user conforming to the selected play mode is located at the hitting plate by the check step S10 above described and hit a real golf ball, the trajectory of the real golf ball hit by the user is calculated in the calculation step S20. In addition, in the display step S30, a virtual golf ball moving according to the calculated trajectory in the virtual golf course is displayed on the screen.

FIG. 15 shows a schematic structure of a virtual golf device according to another embodiment of the present inventive concept.

Referring to FIG. 15, the virtual golf device 100 according to the present embodiment includes a plurality of practice booths 101, 102, 103. Each practice booth has the same structure. For example, the first practice booth 101 includes a hitting plate 101a, a simulator 101b with a small display, a screen 101c, etc., and the other practice booths 102 and 103 also include the same components. Although not shown in FIG. 15, each of the practice booths 101, 102, 103 may further include other components such as a camera for detecting the movement of a golf ball. The virtual golf device 100 according to the present embodiment can be used by one user or a plurality of users to play screen golf or practice golf. The first and second modes described above can be applied when a plurality of users use the virtual golf device 100.

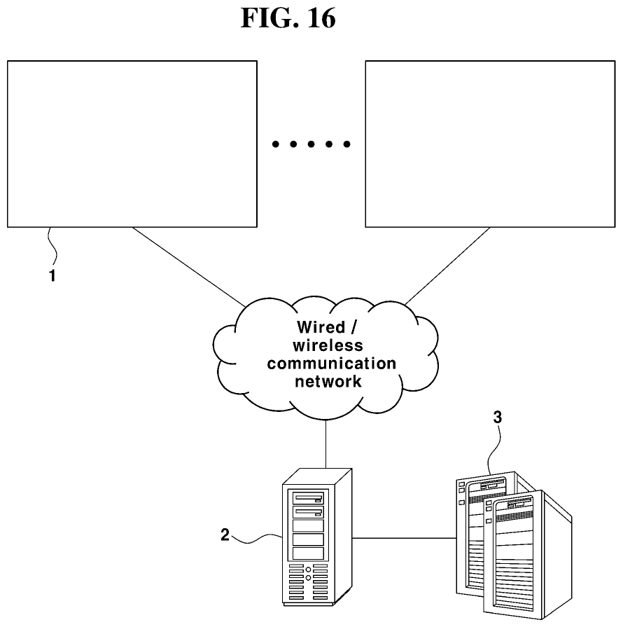

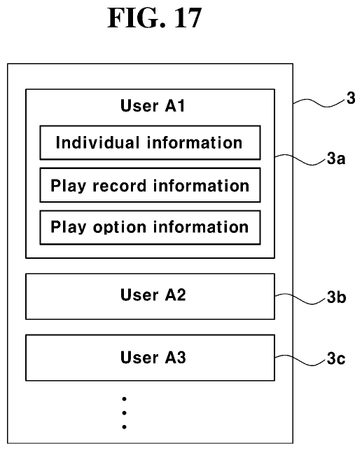

FIG. 16 shows a schematic structure of a virtual golf system according to an embodiment of the present inventive concept, and FIG. 17 shows one example of the structure of the storage unit of the virtual golf system of FIG. 16.

Referring to FIG. 16, the virtual golf system according to the present embodiment comprises at least one virtual golf device 1 and a server unit 2. The virtual golf device 1 is connected to the server unit 2 through a wired/wireless communication network or the like. The virtual golf device 1 serves as a service providing part that provides a screen golf service to a user after the login of the user. The virtual golf device 1 may have the same or similar structure to the virtual golf device described above with reference to FIGS. 1 to 15. In addition, when there are a plurality of users, the first and second modes relating to the hitting order of the users can be applied to the virtual golf device 1.

The server unit 2 may be a central server used by a service provider having a plurality of virtual golf devices to manage the plurality of virtual golf devices. A user needs to log in in order to receive the screen golf service. When a user logs in, the server unit 2 checks the user's identity and determines whether to approve the login. The server unit 2 includes a storage unit 3 that stores information necessary for checking the identity of the user.

Referring to FIG. 17, the storage unit 3 has a plurality of storage sections that are divided for users. For example, if there are different users A1, A2, A3, the storage unit 3 is divided into a storage section 3a for user A1, a storage section 3b for user A2, and a storage section 3c for user A3. The storage section for each user stores an individual information, a play record information, a play option information and the like. The user's individual information includes the user's personal information and can be used in the login process. The user's play record information includes the user's personal records. For example, the play record information can include the play history information about what the user has played in the past. In addition, the play record information can include the play records calculated from the play history information such as the average of number of strokes, the average of a driver distance, etc. The play option information includes a play option frequently used by the user or a play option previously selected by the user. For example, if any one of the first and second modes may be selected and stored in the play option information, the corresponding play mode may be automatically selected when the corresponding user logs in. Concretely, if users A1 and A2 log in together and the first mode is stored as a preferred mode in the play option information of users A1 and A2, the first mode may be set automatically although users A1 and A2 don't select a play mode.

Although the embodiments of the present inventive concept have been disclosed for illustrative purposes, those skilled in the art will appreciate that the present inventive concept may be embodied in other specific ways without changing the technical spirit or essential features thereof. Therefore, the embodiments disclosed in the present inventive concept are not restrictive but are illustrative. The scope of the present inventive concept is given by the claims, rather than the specification, and also contains all modifications within the meaning and range equivalent to the claims.

1. A virtual golf device comprising:
a control part calculating a trajectory of a real golf ball when a user hits the real golf ball; and
a display part displaying a virtual golf ball corresponding to the real golf ball hit by the user and moving according to the calculated trajectory in a virtual golf course,
wherein the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

2. The virtual golf device of claim 1, wherein the user whose virtual golf ball is farthest away from a target point of the virtual golf course hits the real golf ball first in the first mode.

3. The virtual golf device of claim 1, wherein one user among the plurality of users can hit the real golf ball at least two times in a row regardless of the location of the virtual golf ball of the corresponding user in the second mode.

4. The virtual golf device of claim 3, wherein one user among the plurality of users can continuously hit the real golf ball from beginning to end in the virtual golf course in the second mode.

5. The virtual golf device of claim 3, wherein the second mode is applied to a putting step.

6. The virtual golf device of claim 1, further comprising a hitting mat which the user places and hits the real golf ball on,
wherein the hitting mat comprises a plurality of areas and the virtual golf course comprises a plurality of virtual areas corresponding to the plurality of areas of the hitting mat, when the virtual golf ball is located at one of the virtual areas the user should place and hit the real golf ball on one area of the plurality of areas of the hitting mat corresponding to the virtual area where the virtual golf ball is located, and the user can continuously hit the real golf ball while the real golf ball to be hit is placed at the same area of the hitting mat in the second mode.

7. A method for operating a virtual golf device comprising:
a step of calculating a trajectory of a real golf ball when a user hits the real golf ball; and
a step of displaying a virtual golf ball corresponding to the real golf ball hit by the user and moving according to the calculated trajectory in a virtual golf course,
wherein the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

8. The method for operating a virtual golf device of claim 7, further comprising a step of checking whether the user preparing for hitting the real golf is a correct user about the hitting order of the play mode currently selected.

9. A virtual golf system comprising:
a virtual golf device; and
a server unit connected to the virtual golf device through a communication network,
wherein the virtual device comprises a control part calculating a trajectory of a real golf ball when a user hits the real golf ball, and a display part displaying a virtual golf ball corresponding to the real golf ball hit by the user and moving according to the calculated trajectory in a virtual golf course, and
the user can select one play mode of a first mode and a second mode, there are a plurality of users, an order of hitting the real golf ball between the plurality of users in the first mode depends on a location of each user's virtual golf ball in the virtual golf course, and an order of hitting the real golf ball between the plurality of users in the second mode does not depend on the location of each user's virtual golf ball in the virtual golf course.

10. The virtual golf system of claim 9, wherein the server unit comprises a storage unit for storing user's personal information, and the play mode can be set based on the user's personal information without the user's selection.
